(19) United States
(12) Patent Application Publication
(10) Pub. No.: US 2017/0362888 A1
(43) Pub. Date: Dec. 21, 2017

(54) Device and Method for Blind Control and Automation

(71) Applicant: JALOUSIER OU, Tartu (EE)

(72) Inventors: Ksenia Vinogradova, Tartu (EE); Sergei Vinogradov, Tartu (EE); Dmitrii Vinogradov, Tartu (EE)

(21) Appl. No.: 15/527,653

(22) PCT Filed: Nov. 18, 2015
(86) PCT No.: PCT/EE2015/050002

§ 371 Date: May 17, 2017

Related U.S. Application Data
(60) Provisional application No. 62/081,223, filed on Nov. 18, 2014.

(51) Int. Cl. E06B 9/322; E06B 9/38; E06B 9/36

(52) U.S. Cl. CPC E06B 9/322; E06B 9/368; E06B 9/38

(57) ABSTRACT

The invention is related to window blind automation and provides a removable device for blind control and automation. The invention is also related to a method for blind control and automation. The device is attached to window blinds headrail with magnets, hooks or other means and the tilter or the cords are put inside the mechanism. The device has a hole where the adaptor is inserted. There are different types of small adaptors for different types of tilters. There is a light sensor for ambient light which might be hidden under semi-transparent plastic or be visible on the enclosure. In the lower part of the drawing the version for vertical blinds is shown. At the side of the verticals there is a metal shaft and the device connects to it with a gear wheel. For verticals, the device is attached to the side of the headrail.

### TECHNICAL FIELD

The present disclosure generally relates to window blind automation and provides a removable device for blind control and automation. The present invention also provides a method for blind control and automation.

### PRIOR ART

Windows blinds are often regulated by individuals to control a desired room temperature or provide desired room lighting. For example, an individual may desire to optimize heating and cooling as well as natural light associated with a window. Thus, one conventional strategy is to manually adjust the blinds. This often causes problems because it is time consuming, requires constant monitoring, and is prone to hardware malfunction. Alternatively, automated blinds exist but are expensive, require a control panel and wires that must run to them, and may require professional installation.

### BRIEF DESCRIPTION OF THE INVENTION

The present disclosure provides a removable device and method for blind control and automation. The removable device for blind control and automation is used by to automate blinds for optimizing heating, cooling and natural lighting to save energy on artificial lighting and climate control. The device is easily attachable to blinds and is controlled automatically or wireless.

### LIST OF THE DRAWINGS

Preferred embodiments of the invention are described with accompanying drawings, wherein the drawings represent following:

FIG. 1A-1G illustrates side view, front view, back view, angled views, and overall views of both sides of the device and the adaptor suitable for one common type of blind design;

FIG. 2 illustrates the device of the FIG. 1 prior attaching the device to headrail of blinds;

FIG. 3 illustrates overall view of the device suitable for another type of blind design;

FIG. 4A-4C illustrates top view, end view and side view of the device illustrated on FIG. 3;

FIG. 5 illustrates the device of the FIG. 3 prior attaching the device to headrail of blinds;

FIG. 6 illustrates yet another embodiment of the device adopted for cord controlled blinds;

FIG. 7 illustrates a block diagram of an operating environment consistent with the present invention;

FIG. 8 is a block diagram of a system including a computing device for performing the control for the apparatus.

### DETAILED DESCRIPTION OF THE INVENTION

The device 1 for blind control and automation is a removable add-on and smart device to automate an individual's ordinary window blinds. As any electronic device, the device for blind control and automation comprises of hardware and software components. The device comprises built-in sensors, attaching means, a casing, wherein inside the casing is a motor to which a block of gear wheels (drive) is connected, an electronic circuit board and a microcontroller, power connectors, LED indicator(s) (not shown). On back side of the device, there are visible or covered attaching means, which are magnets, hooks, double stick tape, an adaptor, or other means to connect to the headrail depending on its material. With the attaching means, the device is configured to clip onto existing blind (e.g., venetian blinds). In another embodiment of the invention the device is connectable to existing window blinds hardware, for example, to cords and tilter.

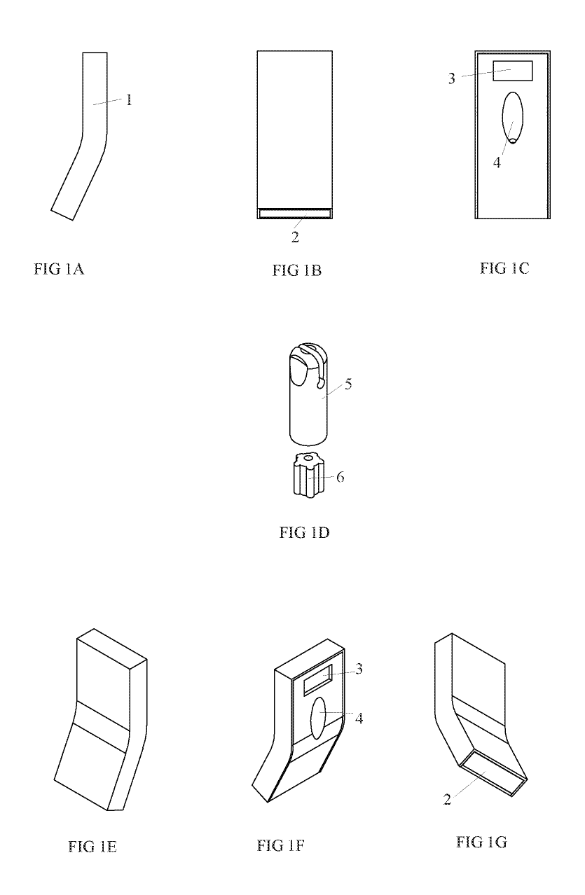

As shown on FIG. 1B, on the indoor facing side of the device 1, on its lower part there is an ambient light sensor 2 to measure lighting conditions. The sensor can be visible or placed under semi-transparent plastic cover. On back side (see FIG. 1C, 1F), on top part of the device 1 there are visible or covered and discrete magnets, hooks, double stick tape, or other means 3 to connect to the headrail. On the back side of the device there is hole 4 where the tilter 5 with adaptor 6 is placed. The device has a hole 4 where the tilter 5 (with an adaptor 6 on it) is inserted. There are different types of small adaptors for different types of tilters. Adaptors are small plastic parts, which translate different types of tilters to a universal interface, which is connected directly or through gear wheels to the motor shaft.

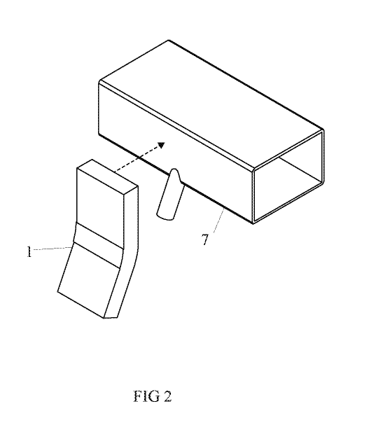

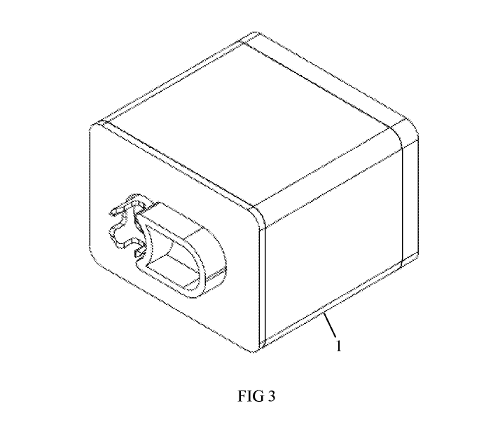

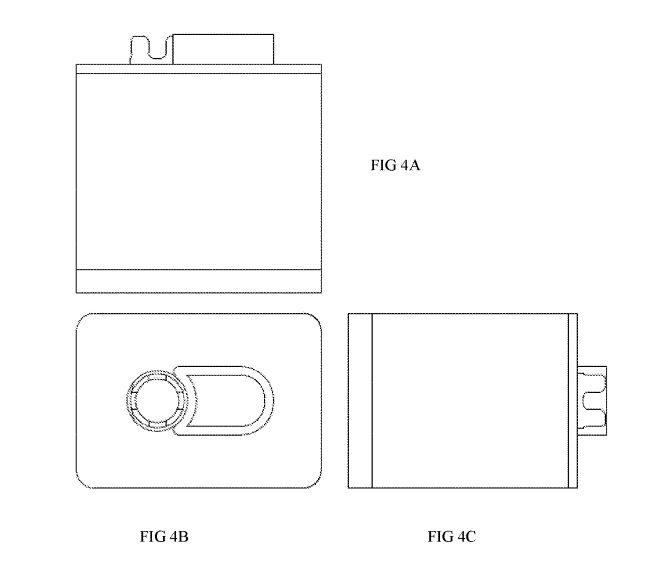

As shown on FIG. 2, the device 1 is attached to headrail 7 and connects to this mechanism. Headrail is shown with the tilter mechanism sticking out. The device is attached to headrail and connects to this mechanism. In case of horizontal blinds, the device is placed on the side where the existing tilting controls are. In case of another type of blinds, the device 1 is placed on the side where the existing tilting controls are (see FIGS. 3-5). Once configured to the blind, the apparatus is configured to operate to adjust automatically a position of slats according to the room temperature, lighting conditions, changing weather and time of day. In one embodiment of the invention, the removable device for blind control and automation is used in conjunction with, for example, a smartphone application. In this embodiment, the smartphone application is in remote communication with the device, configured to control the various settings and functions for the device. Alternatively, the device is integrated into existing home automation system and is configured to be controlled through the third party gateway and interface application. The device communicates with other devices via Bluetooth Low Energy, Wi-Fi, Z-wave or ZigBee. For some applications the gateway is used to control several devices.

The device for blind control and automation comprises built-in sensors, which respond to changing light and temperature. The built-in sensors are LDR (Light Dependent Resistor) lighting and temperature sensors. Preferably, it is configured to track changes in lighting and temperature conditions and to adjust blinds correspondingly. On the indoor facing side of the device there is an ambient light sensor to measure lighting conditions. The sensor is visible or placed under semi-transparent plastic cover. Inside the device there is a temperature sensor, which is invisible. When several devices are controlled and connected simultaneously, the application shows an average temperature among the devices in the group.

In preferred embodiment of the invention, the device is battery operated. In one embodiment, the batteries are rechargeable through a solar panel. The solar panel sticks to the window glass from indoors on sucker cups or is attached to headrail with hooks or by other means and charges the battery of the device. The solar panel may be fitted with a light sensor to measure daylight as well. The device may be connected to other source of energy for charging as well, via micro USB cable.

Another feature that comes with the device is CordBox. CordBox provides safer environment for children and pets. It is a small box with retracting mechanism inside—it retracts the cords of the blind inside and can either hang right below the device, stick to the headrail or stick to the device on magnet. The purpose is to eliminate the danger of kids and pets strangling in the cord loop.

### Attaching the Device for Blind Control and Automation

Device is attached to non-motorized, ordinary simple window blinds. The device is fitted with motor, which connects to existing window blinds mechanism. The device actuates existing window blind tilting mechanism to adjust slats angle when it needs to respond to changing environment.

The existing slats adjusting mechanism of blinds is usually activated by a) twisting wand, b) pulling cords, c) rotating the tilting shaft.

The existing wand needs to be detached and one of the adaptors is installed on the remaining tilter. (horizontal blinds)

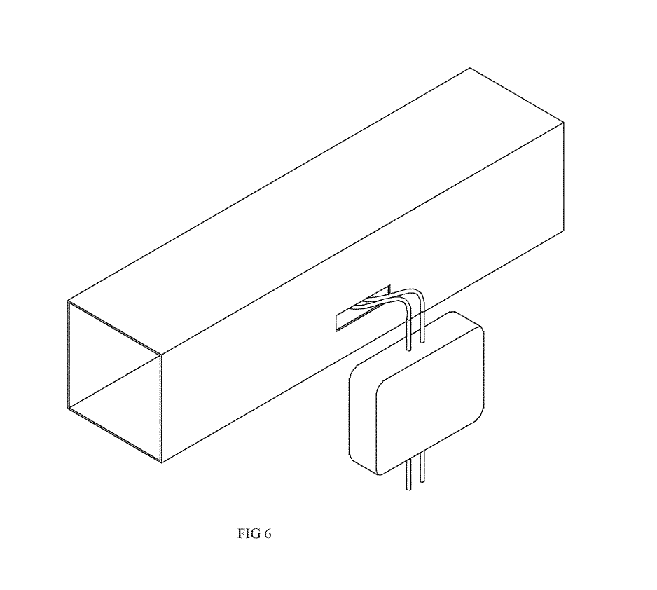

In case of cord-controlled blinds (see FIG. 6), the cords are pulled into the mechanism and and fixed by a) winding around two different gears, b) clamping by gear wheels, c) fixing with nods or stoppers, all and any of which will be independently rotated by the motor in two different directions, one at a time. (horizontal blinds)

In case of vertical blinds, the device is installed as a cap on the side of the headrail—as on side of it there is a shaft sticking out. In case of vertical blinds we connect the motor directly to the rotating shaft of the mechanism. (vertical blinds)

The motor is connected to tilting mechanism through an adaptor or one or more adjacent gear wheels. The adaptor or gear wheel is put on top of the motor shaft as a cap. The adaptor or gear wheel can be placed inside the enclosure or be separate and changeable parts.

When the microcontroller decides to change angle of window blinds, it actuates the motor, the motor starts rotating and the adaptor or gear wheels start rotating accordingly together with it.

The moving adaptor or gear wheel spin a) the tilter (horizontal blinds)? b) winds the cords (horizontal blinds)? or c) the shaft (vertical blinds). It actuates the tilting mechanism and the slats start moving. The motor can spin the tilter and gear wheels in two opposite directions to the specific angle, which is defined by program (algorithm).

The device is placed either on the side of the headrail, where the manual tilting controls are, or the device is placed as a cap on the side of the headrail, opposite to the side with manual controls.

No tools are necessary to install device for blind control and automation on existing blinds. E.g. in case of venetian blinds, wand or cords for manual control need to be detached and the device will be clipped to the regulating mechanism, which replaces manual control with automatic control.

In case of cord-controlled blinds the cords shall be pulled into apparatus mechanism. To connect hardware of window blinds to the motor different inserts (adaptors) are used.

### Horizontal Blinds:

The existing angle adjusting mechanism of horizontal blinds is activated with either a) wand, or b) with cords. The device connects directly to existing mechanism.

The existing wand is detached and the remaining tilter shall be covered with one of the adaptors. The device has a hole where the tilter (with an adaptor on it) is inserted. There are different types of small adaptors for different types of tilters. Adaptors translate different types of tilters to a universal interface on the other side of it—which is connected directly or through gear wheels to the motor shaft.

In case of cord-controlled blinds, the cords are pulled into the mechanism and winded around two different gears, which will be independently rotated by the motor in two different directions, one at a time.

### Vertical Blinds:

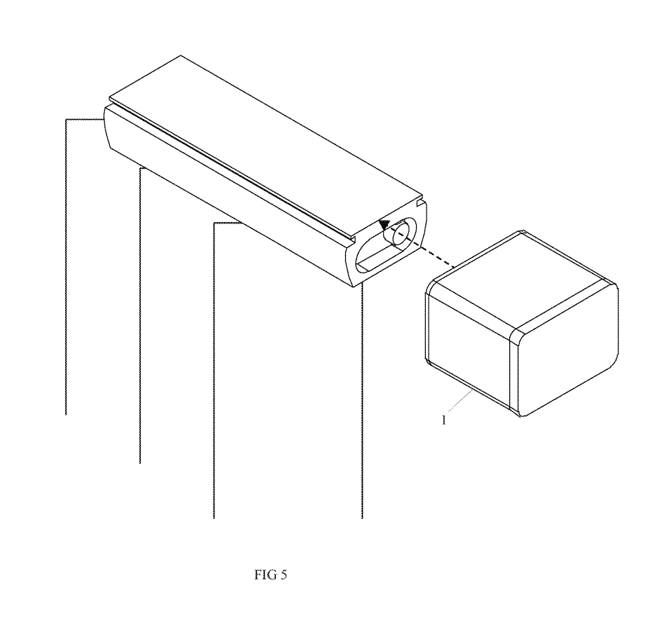

As shown on FIG. 5, at the side of the headrail part of the rotating metal shaft is slightly sticking out, so the device connects to this shaft with a gear wheel, which is connected directly to motor.

In case of vertical blinds, the device is installed as a cap on the side of the headrail, which is opposite to the side with manual controls. At the side of the headrail part of the rotating metal shaft is slightly sticking out, so the device connects to this shaft with a gear wheel, which is connected to motor directly.

### Use of the Device for Blind Control and Automation

Settings are made for a group of the devices. Each group has at least one device added.

The user sets desired temperature and amount of sunlight in the smart phone application and it defines which algorithm the device will use. In particular, if the current indoor temperature is lower than the setting in application, the device will keep the slats in position, which provide more sunlight inside (heating mode). If the current indoor temperature is higher than provided by the setting, the device turns slats into position which blocks direct sunlight and heating, reflect light to the ceiling or close the slats completely.

The angle of slats positions is defined by the desired amount of sunlight in the room as well—slats can either allow or block direct sunlight and glare. The temperature adjustment is more important over light amount, i.e. of two settings (light amount and temperature) the temperature prevails.

The device for blind control and automation comprises also a timer and receives information about time, date and weather conditions from the smart phone application. In particular, during night, the device is in sleep mode and after sunset slats will be closed if the indoor lights are switched on and at sunrise the slats will open again.

The device for blind control and automation is configured to:
a) respond to changing temperature and light conditions according to measurements of sensors for each part of a day (automatic mode);
b) open/close blinds at certain time (schedule);
c) change position of slats instantly and hold for a certain period of time (manual mode);
d) get and receive commands to and from other home automation devices, for example controllers, lightbulbs, switches, thermostats, sensors, door locks, alarms, cameras, etc (smart home mode).

Manual mode overrides schedule, smart home and automatic mode. Schedule overrides automatic mode. Smart home mode overrides all modes.

### Software Application of the Device for Blind Control and Automation

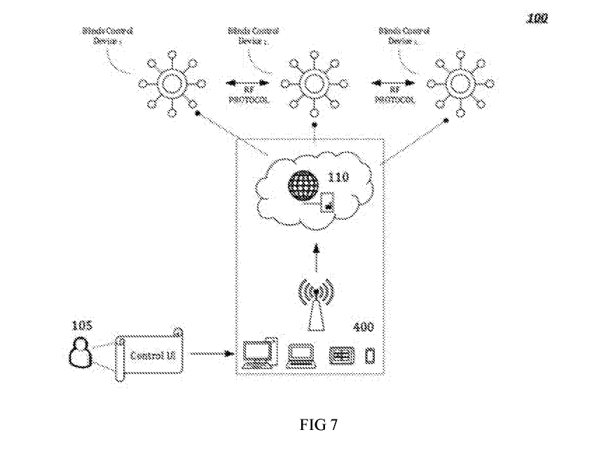

FIG. 7 illustrates one possible operating environment through which a platform consistent with embodiments of the present disclosure is provided. A platform 100 is hosted on a centralized server 110, such as, for example, a cloud computing service. A user 105 accesses the platform 100 through a software application. The software application is embodied as, for example, a website, a web application, a desktop application, and a mobile application compatible with a computing device 400. One possible embodiment of the software application may be provided by the Elfy™ suite of products and services provided by Jalousier OÜ.

User 105 can platform 100 via computing device 400 (e.g., smartphone) to set the desired room temperature, daylight, and various other settings. For example, server 110 may host a user interface through which user 105 controls the various functions and features of the apparatus. In some embodiments, computing device 400 is configured to connect to the apparatus via, for example, ZigBee, Wi-Fi or Bluetooth connections, thereby by-passing server 110.

Consistent with embodiments of the disclosure, some of the settings and features that may be controlled by the user interface include, for example:
Managing settings and modes—Program preferred position of blind slats in the morning and in the evening, for different seasons, weekdays, etc.;
Gesture control your blinds—In case the device is controlled from a smartphone with a gyroscope, one can adjust the blinds by tilting the phone and the device will sync position of the slats with position of the phone;
Schedule blinds to own lifestyle—One can schedule a position of the blinds slats for different time of the day and weekdays according to his/her own pace of life and needs;
Sync blinds to an alarm clock;
Get push-notifications on natural phenomena ZigBee allows for
Controlling several devices by groups—To control several devices in a group (e.g. kitchen, bedroom) one can unite several devices into groups and control them simultaneously;
Shared access with family or colleagues in the office;
Integration to smart home systems—The device can integrate into the third-party smart home systems if they share the same wireless communication protocol. Inside the system, it may coordinate blinds position with smart lighting or climate control, metering and other home automation solutions; and
Slot for Electric Imp Wi-Fi card for remote control and settings from virtually anywhere; and profile and settings storage on cloud.

In one embodiment, the platform 100 is embodied as, for example, but not be limited to, a website, a web application, a desktop application, and a mobile application compatible with a computing device. The computing device comprises, but is not limited to, a desktop computer, laptop, a tablet, or mobile telecommunications device. Moreover, the platform 100 is hosted on a centralized server, such as, for example, a cloud computing service. Although the control method has been described to be performed by a computing device 400, it should be understood that, in some embodiments, different operations may be performed by different networked elements in operative communication with computing device 400.

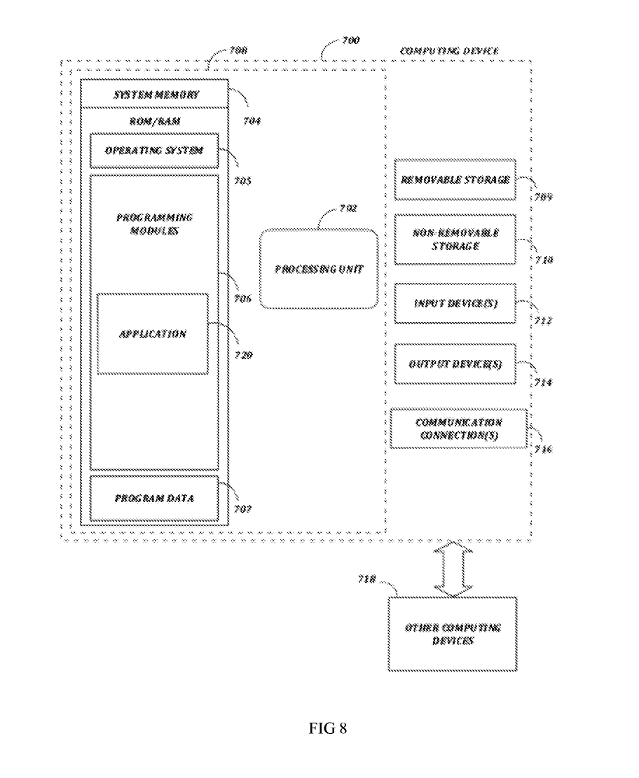

FIG. 8 is a block diagram of a system including computing device 700. Consistent with an embodiment of the disclosure, the aforementioned memory storage and processing unit are implemented in a computing device, such as computing device 700 of FIG. 8. Any suitable combination of hardware, software, or firmware is used to implement the memory storage and processing unit. For example, the memory storage and processing unit are implemented with computing device 700 or any of other computing devices 718, in combination with computing device 700. The aforementioned system, device, and processors are examples and other systems, devices, and processors may comprise the aforementioned memory storage and processing unit, consistent with embodiments of the disclosure.

With reference to FIG. 8, a system consistent with an embodiment of the disclosure includes a computing device, such as computing device 700. In a basic configuration, computing device 700 includes at least one processing unit 702 and a system memory 704. Depending on the configuration and type of computing device, system memory 704 comprises, but is not limited to, volatile (e.g. random access memory (RAM)), non-volatile (e.g. read-only memory (ROM)), flash memory, or any combination. System memory 704 includes operating system 705, one or more programming modules 706, and includes a program data 707. Operating system 705, for example, is suitable for controlling computing device 700′s operation. In one embodiment, programming modules 706 include application 720. Furthermore, embodiments of the disclosure practice in conjunction with a graphics library, other operating systems, or any other application program and are not limited to any particular application or system. This basic configuration is illustrated in FIG. 3 by those components within a dashed line 708.

In alternative embodiments, computing device 700 has additional features or functionality. For example, computing device 700 also includes additional data storage devices (removable and/or non-removable) such as, for example, magnetic disks, optical disks, or tape. Such additional storage is illustrated in FIG. 8 by a removable storage 709 and a non-removable storage 710. Alternatively, computer storage media includes volatile and non-volatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Alternatively, computer storage media includes, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium, which can be used to store information and which can be accessed by computing device 700. In some embodiments, any such computer storage media is part of device 700. In some embodiments, computing device 700 also has input device(s) 712 such as a keyboard, a mouse, a pen, a sound input device, a touch input device, etc. Output device(s) 714 such as a display, speakers, a printer, etc. are also included. The aforementioned devices are examples and others may be used.

Computing device 700 also contains a communication connection 716 that allows device 700 to communicate with other computing devices 718, such as over a network in a distributed computing environment, for example, an intranet or the Internet. Communication connection 716 is one example of communication media. Communication media is typically embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. In one embodiment, and not limitation, communication media includes wired media such as a wired network or direct-wired connection, and wireless media such as acoustic, radio frequency (RF), infrared, and other wireless media. The term computer readable media as used herein includes both storage media and communication media.

As stated above, a number of program modules and data files are stored in system memory 704, including operating system 705. While executing on processing unit 702, programming modules 706 (e.g., application 720) perform processes, including those mentioned above. The aforementioned process is an example, and processing unit 702 can also perform other processes. Other programming modules that are used in accordance with embodiments of the present disclosure include electronic mail and contacts applications, word processing applications, spreadsheet applications, database applications, slide presentation applications, drawing or computer-aided application programs, etc.

Generally, consistent with embodiments of the disclosure, program modules include routines, programs, components, data structures, and other types of structures that perform particular tasks or that implement particular abstract data types. Moreover, alternative embodiments of the disclosure are practiced with other computer system configurations, including hand-held devices, multiprocessor systems, microprocessor-based or programmable consumer electronics, minicomputers, mainframe computers, and the like. Some embodiments of the disclosure are also practiced in distributed computing environments, where tasks are performed by remote processing devices that are linked through a communications network. In a distributed computing environment, program modules are located in both local and remote memory storage devices.

Furthermore, some embodiments of the disclosure are practiced in an electrical circuit comprising discrete electronic elements, packaged or integrated electronic chips containing logic gates, a circuit utilizing a microprocessor, or on a single chip containing electronic elements or microprocessors. Other embodiments of the disclosure are practiced using other technologies capable of performing logical operations such as, for example, AND, OR, and NOT, including but not limited to mechanical, optical, fluidic, and quantum technologies. In addition, some embodiments of the disclosure may be practiced within a general purpose computer or in any other circuits or systems.

Some preferred embodiments of the disclosure, for example, are implemented as a computer process (method), a computing system, or as an article of manufacture, such as a computer program product or computer readable media. The computer program product is a computer storage media readable by a computer system and encoding a computer program of instructions for executing a computer process. Alternatively, the computer program product is a propagated signal on a carrier readable by a computing system and encoding a computer program of instructions for executing a computer process. Accordingly, the present disclosure is embodied in hardware and/or in software (including firmware, resident software, micro-code, etc.). In other words, embodiments of the present disclosure take the form of a computer program product on a computer-usable or computer-readable storage medium having computer-usable or computer-readable program code embodied in the medium for use by or in connection with an instruction execution system. A computer-usable or computer-readable medium is any medium that contains, stores, communicates, propagates, or transports the program for use by or in connection with the instruction execution system, apparatus, or device.

The computer-usable or computer-readable medium is, for example but not limited to, an electronic, magnetic, optical, electromagnetic, infrared, or semiconductor system, apparatus, device, or propagation medium. More specific computer-readable medium examples (a non-exhaustive list), the computer-readable medium includes the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Alternatively, the computer-usable or computer-readable medium is paper or another suitable medium upon which the program is printed, as the program is electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks can also occur out of the order as shown in any flowchart. For example, two blocks shown in succession in fact execute substantially concurrently or the blocks sometimes execute in the reverse order, depending upon the functionality/acts involved.

While certain embodiments of the disclosure have been described, other embodiments may exist. Furthermore, although embodiments of the present disclosure have been described as being associated with data stored in memory and other storage mediums, alternatively, data is stored on or read from other types of computer-readable media, such as secondary storage devices, like hard disks, solid state storage (e.g., USB drive), or a CD-ROM, a carrier wave from the Internet, or other forms of RAM or ROM. Further, alternatively, the disclosed methods' stages are modified in any manner, including by reordering stages and/or inserting or deleting stages, without departing from the disclosure.

1. A device for blind control and automation characterized in that the device comprises a casing with a hole for inserting a tilter of blinds, a tilting mechanism, electronic circuit board, microcontroller, light and temperature sensors, LED indicator, battery element and/or power connectors, attaching means and cord box,
wherein the tilting mechanism comprises a motor, at least one adaptor or a block of at least one gear wheel;
the motor is connected to tilting mechanism through the adaptor or block of gear wheels;
the adaptor or block of gear wheels is on top of the motor shaft as a cap;
the motor is configured to rotate the adaptor or block of gear wheels.

2. A device according to claim 1, characterized in that the attaching means are magnets or hooks or double stick tape or an adaptor.

3. A device according to claim 1, characterized in that light and temperature sensors are visible or placed under semi-transparent plastic cover.

4. A device according to claim 1, characterized in that the battery element is a rechargeable battery with solar panel, which is attached to a window glass from indoors or to the headrail of blinds.

5. A device according to claim 1, characterized in that the power connector is a micro USB cable.

6. A device according to claim 1, characterized in that the cord box comprises retracting mechanism which is configured to retract the cords of the blinds inside the cord box and the cord box hangs right below the device or sticks to the headrail or on the device with magnet.

7. A method for blind control and automation characterized in that the device 1 is attached to tilter of blinds,
the microcontroller actuates the motor, the motor starts rotating and the adaptor or gear wheels start rotating accordingly together with the motor and change the angle of window blinds.

8. A method according to claim 7 characterized in that the device is attached to tilter of blinds by placing the device on the side of the manual tilting control mechanism.

9. A method according to claim 7 characterized in that the device is attached to tilter of blinds by detaching existing wand and installing an adaptor on the tilter.

10. A method according to claim 7 characterized in that the device is attached to tilter of blinds by placing the device as a cap on a rotating shaft, which is on a side of the headrail opposite to the side with manual controls, and whereby the motor is connected directly to the rotating shaft.

11. A method according to claim 7 characterized in that the device is attached to tilter of blinds by detaching existing cords for manual control and the cords are pulled into apparatus mechanism through a hole of a casing and the cords are winded around two different gear wheels or clamped by gear wheels or fixed with nods or stoppers, which are configured to be independently rotated by the motor in two different directions, one at a time.

12. A method according to claims 7 to 11 characterized in that the rotating adaptor or block of gear wheels actuate the tilting mechanism and by spinning the tilter or shaft or winding the cords, the slats start moving;
the motor spins the tilter and block of gear wheels in two opposite directions to the specific angle, which is defined by program.
